(19) United States
(12) Patent Application Publication
(10) Pub. No.: US 2010/0104809 A1
(43) Pub. Date: Apr. 29, 2010

(54) COOL ROOF COVERING

(76) Inventors: Joseph F. Duda, North Olmsted, OH (US); Edward J. Buczek, Brunswick, OH (US); Donald L. McDowell, Geneva, OH (US)

Correspondence Address: Heidi A. Boehlefeld, Esq.;Renner, Otto, Boisselle & Sklar, LLP, 19th Floor, 1621 Euclid Ave., Cleveland, OH, 44115, US

(21) Appl. No.: 12/606,701

(22) Filed: Oct. 27, 2009

Related U.S. Application Data
(60) Provisional application No. 61/108,760, filed on Oct. 27, 2008.

(51) Int. Cl. B32B 3/10; C09D 133/02; C08K 3/22; C08K 3/38; C08K 3/10; C08K 3/30

(52) U.S. Cl. 428/143; 524/556; 524/432; 524/430; 524/436; 524/405; 524/437; 524/420

(57) ABSTRACT

A cool roof covering that includes a protective coating formed from an aqueous coating composition and aggregate embedded in the protective coating, wherein the roof covering has a solar reflectance of at least 70% and a thermal emittance of at least 0.75.

This application claims the benefit of U.S. Provisional Application No. 61/108,760 filed Oct. 27, 2008, the contents of which are hereby incorporated by reference in their entirety.

### TECHNICAL FIELD

The present invention relates generally to roofing materials, and more particularly, to a roof covering having high solar reflectance and high thermal emittance.

### BACKGROUND

Cool roofs reflect incoming radiation back into the atmosphere (reflectance) and help the roof release trapped heat (emittance). By cooling the roof and reducing heat transfer into the underlying building, cool roofs reduce the cooling load of the building's heating, ventilation and air conditioning system, thereby reducing energy consumption and saving money while minimizing greenhouse gas emissions. The increased reflectivity of the roofing also increases the life of the roofing by reducing the rate of thermal degradation.

The California Energy Commission's Building Energy Efficiency Standard, Title 24, includes a cool roof prescription for low-slope (less than 2:12) nonresidential roofs for new construction and major re-roofing. Section 10-113 requires that cool roofs be tested and labeled by the Cool Roof Rating Council. Title 24 defines a cool roof as “Any roofing product with an initial thermal emittance greater than or equal to 0.75 when tested in accordance with CRRC-1, and a minimum initial solar reflectance of 0.70 when tested in accordance with CRRC-1.”

In addition to providing roofing material having high solar reflectance and high thermal emittance, it is desirable to provide roofing material having reduced VOC. However, efforts to reduce the VOC of coating composition often results in coatings having inferior coating performance.

### SUMMARY

In one aspect of the invention there is provided a cool roof covering that includes: a substrate having an upper surface; a protective coating covering at least a portion of the upper surface of the substrate, wherein the coating is the dried film of an aqueous composition including (a) a water resistant styrene-acrylic emulsion polymer, (b) at least one reflective pigment, (c) a flame retardant, and (d) a light weight filler having a density of no greater than 0.7 lb/gal (0.084 g/cc). The cool roof covering also includes a layer of aggregate at least partially embedded in the protective coating. The cool roof covering has a solar reflectance of at least 70% and a thermal emittance of at least 0.75.

In one embodiment, the aqueous composition has a VOC of less than 50 grams/liter. The water resistant styrene-acrylic emulsion polymer, in one embodiment, has a Tg of about 7° C. and a minimum film forming temperature (MFFT) of <2° C.

In one embodiment, the reflective pigment is selected from rutile titanium dioxide, anatase titanium dioxide, zinc oxide, zirconium oxide, barium sulfate, titanium calcium, antimony oxide, zinc sulfide and mixtures of two or more thereof.

In one embodiment, the light weight filler is a composite microsphere having an acrylonitrile copolymer shell and an exterior coating of calcium carbonate affixed to the shell.

In one embodiment, the aqueous composition has a density in the range of about 8.5 to about 10 lbs/gal.

In one embodiment, the flame retardant of the aqueous composition is selected from alumina trihydrate, magnesium hydroxide, zinc borate and mixtures of two or more thereof.

In one embodiment, the aggregate has a solar reflectance of about 72% and a thermal emittance of about 0.78.

In one embodiment, the aggregate is selected from granite, marble, limestone, and ceramic coated rock and mineral material. The aggregate may include ceramic coated natural rock having a solar reflectance of 72% and a thermal emittance of 0.78.

In one embodiment, the substrate is a built up roof (BUR). In another embodiment, the substrate is a modified bitumen (MB) substrate.

In one embodiment, the dried coating composition has an elongation (according to ASTM D2370) of at least 400%.

In one aspect of the invention, there is provided a cool roof coating that includes the dried film of an aqueous composition comprising (a) a water resistant styrene-acrylic emulsion polymer, (b) at least one reflective pigment, (c) a flame retardant, and (d) a light weight filler having a density of no greater than 0.7 lb/gal (0.084 g/cc), wherein the coating has an elongation (according to ASTM D2370) of at least 400%.

### DETAILED DESCRIPTION

The present invention relates to a roofing material that includes a base substrate having an upper surface; a protective coating covering at least a portion of the upper surface of the base layer and reflective granules embedded the protective coating. The roofing material has a solar reflectance of at least 70% (according to ASTM C-1549-02) and a thermal emittance of at least 0.75 (according to ASTM C-1371-98).

The roofing substrate to which the protective coating is applied may include, for example, modified bitumen or built-up roofing. In general, the roofing material is particularly useful for low slope roof applications. Modified bitumen (MB) incorporates the use of a composite fabric that is impregnated with a bituminous composition. The composite fabric typically includes a layer of woven or nonwoven material connected to a layer of low shrinkage warp strands and/or a layer of low shrinkage weft strands. The layers are typically stitched or knitted together, and the resultant fabric may be coated with a resin or sizing to prevent slippage between the several layers of the fabric and impart a measure of stiffness to the fabric. The fibers comprising the warp stands, the weft strands, and/or the woven or nonwoven material can include fibers selected from a variety of sources such as, but not limited to, natural materials, polymeric materials, inorganic materials and combinations thereof. Non-limiting examples of such fibers include polycrystalline fibers, fiberglass, thermoplastic fiber filaments (e.g., polyamide fibers of poly (p-phenylene terephthalate), poly (o-phenylene terephthalamide), ultra low shrink polyester), cotton, cellulose, natural rubber, flax, ramie, hemp, sisal, wool, linen (flax), paper, wood pulp, polyamides, polyesters, acrylics, polyolefins, polyurethanes, vinyl polymers, and derivatives and mixtures thereof.

Built-up roofing (BUR) systems generally include a substantially rigid deck covered with a membrane comprising one or more layers of bituminous composition impregnated felt having a separately applied coating of bituminous composition on top of each layer of felt. BUR is used primarily on commercial buildings that have flat or low-slope roofing systems.

The protective coating that covers the substrate is formed from an aqueous coating composition that includes a water resistant styrene-acrylic emulsion polymer, at least one reflective pigment, a flame retardant and a light weight filler.

The protective coating is formed by applying a layer of the aqueous coating composition over at least a portion of the upper surface of the substrate. Before the aqueous coating composition has dried, the aggregate is applied to the protective coating layer so that the aggregate becomes embedded in the wet coating composition layer.

The aqueous coating composition that forms the protective coating includes at least one emulsion polymer. The latex polymer suitable for use in the present invention may include an emulsion polymer of mono- or poly-ethylenically unsaturated olefinic, vinyl or acrylic monomers, including homopolymers and copolymers of such monomers. Specifically, the dispersed polymer may include copolymers of one or more of acrylic and methacrylic acid esters, vinyl chloride, vinylidene chloride, styrene, vinyltoluene, acrylonitrile, methacrylonitrile, acrylamide, methacrylamide, maleic acid and esters thereof. Copolymers of one or more of C₂-C₄₀ alpha olefins such as ethylene, isobutylene, octene, nonene, and styrene with one or more esters, nitriles or amides of acrylic acid or of methacrylic acid or with vinyl esters, such as vinyl acetate and vinyl chloride, or with vinylidene chloride; and diene polymers, such as copolymers of butadiene with one or more of styrene, vinyl toluene, acylonitrile, methacrylonitrile, and esters of acrylic acid or methacrylic acid. An acid monomer may be included in the monomer mixture used for making the copolymers mentioned above by emulsion polymerization. Acids used include acrylic, methacrylic, itaconic, citraconic, crotonic, maleic, fumaric, the dimer of methacrylic acid.

The vinyl acetate copolymers are well-known and include copolymers such as vinyl acetate/butyl acrylate/2-ethylhexyl acrylate, vinyl acetate/butyl maleate, vinyl acetate/ethylene, vinyl acetate/vinyl chloride/butyl acrylate and vinyl acetate/vinyl chloride/ethylene.

Other suitable monomers from which the latex binder may be polymerized from include at least one or more of the following monomers, such as, for example, acrylic and methacrylic ester monomers including methyl (meth)acrylate, ethyl (meth)acrylate, butyl (meth)acrylate, 2-ethylhexyl (meth)acrylate, decyl (meth)acrylate, lauryl (meth)acrylate, isobornyl (meth)acrylate, isodecyl (meth)acrylate, oleyl, (meth)acrylate, palmityl (meth)acrylate, stearyl (meth)acrylate, hydroxyethyl (meth)acrylate, and hydroxypropyl (meth)acrylate; acid functional monomers, such as, acrylic acid, methacrylic acid, crotonic acid, itaconic acid, fumaric acid and maleic acid; monomethyl itaconate; monomethyl fumarate; monobutyl fumarate; maleic anhydride; acrylamide or substituted acrylamides; sodium vinyl sulfonate; phosphoethyl(meth)acrylate; acrylamido propane sulfonate; diacetone acrylamide; glycidyl methacrylate; acetoacetyl ethylmethacrylate; acrolein and methacrolein; dicyclopentadienyl methacrylate; dimethyl meta-isopropenyl benzyl isocyanate; isocyanato ethylmethacrylate; styrene or substituted styrenes; butadiene; ethylene; vinyl acetate or other vinyl esters, N-vinyl pyrrolidone; amino monomers, such as, for example, N,N′-dimethylamino and (meth)acrylate. The coating composition is asphalt free.

The polymerization techniques used for preparing the latex binder of the present invention are well known in the art. The binder may be prepared by emulsion polymerization.

In one embodiment, the binder includes a styrene/acrylic polymer. An example of a suitable commercially available styrene/acrylic polymer is TEXICRYL® 13-034 (Scott Bader), which has a percent solids of 50%, viscosity of 1000-4750 cps, Tg 7° C., and minimum film forming temperature (MFFT) of <2° C. Other styrene/acrylic polymers available from Scott Bader include TEXICRYL® 13-061, which has a percent solids of 50%, viscosity of 500-1200 cps, Tg 11° C., and MFFT of 0° C. and TEXICRYL® 13-095, which has a percent solids of 51.5%, viscosity of 300-2000 cps, Tg −22° C.

In one embodiment, the coating composition includes about 20-60% by weight of a water resistant styrene-acrylic emulsion polymer. In another embodiment, the coating composition includes about 30-50% by weight, or about 35-45% by weight of a water resistant styrene-acrylic emulsion polymer.

The coating composition includes at least one reflective pigment that deflects light and heat away from the roof and protects the binder and underlying substrate from the damaging effects of the sun. Suitable reflective pigments include rutile and anatase titanium dioxide, zinc oxide, zirconium oxide, barium sulfate, titanium calcium, antimony oxide, zinc sulfide and mixtures of two or more thereof. In one embodiment, the coating composition includes about 5-25% by weight of a reflective pigment. In another embodiment, the coating composition includes about 7-20% by weight, or about 9-15% by weight of a reflective pigment.

In addition to the reflective pigment, the coating composition includes a light weight filler having a density of no greater than 0.7 lb/gal (0.084 g/cc). In one embodiment, the coating composition includes about 0.2-5% by weight of light weight filler. In another embodiment, the coating composition includes about 0.4-2% by weight, or about 0.5-1% by weight of light weight filler.

In one embodiment, the light weight filler includes hollow microspheres that increase the opacity of the surface coating. The hollow microspheres also provide increased coverage. The hollow microspheres may have a diameter of up to about 300 microns. In one embodiment, the microspheres have a mean diameter in the range of about 50 to about 250 microns, or in the range of about 100 to about 150 microns. In one embodiment, the microspheres have a mean diameter in the range of about 20 to about 80 microns, or from about 30 to about 60 microns. The density of the hollow microspheres is preferably less than about 0.7 lbs/gal (0.084 g/cc), or less than about 0.6 lbs/gal. (0.072 g/cc).

The hollow microspheres may be made from materials that include, for example, polymeric materials such as acrylics, acrylonitrile, polyvinyl chloride and polystyrene; ceramic, glass, carbon, graphite and alumina. In one embodiment, the microspheres include an ultra-low density polymeric microsphere shell to which is affixed an inert exterior coating. For example, the microsphere may be an acrylonitrile copolymer shell having a calcium carbonate exterior coating. Suitable microspheres include those available from Sovereign Specialty Chemicals under the tradename DUALITE® E065-135D.

The coating composition may further include a flame retardant. Useful flame retardants include, for example, alumina trihydrate, magnesium hydroxide, zinc borate and mixtures of two or more thereof. In one embodiment, the coating composition includes about 7-25% by weight of flame retardant. In another embodiment, the coating composition includes about 10-20% by weight, or about 12-18% by weight of flame retardant.

Dispersants such as polyacrylate or polyphosphate, may be used as a dispersing aid and for stabilizing the dispersion. Potassium tripolyphosphate or other types of condensed phosphates may be used.

The coating composition may be thickened using conventional coating thickeners. For example, cellulosic thickeners such as methyl cellulose and hydroxyethyl cellulose may be used. Other types of thickeners and rheology modifiers may be used. The coating composition may further include conventional coating ingredients such as preservatives, antimicrobial agents, mildewcides, antifreeze agents, coalescents, defoaming agents, colorants, dyes, cosolvents, plasticizers, UV stabilizers and adhesion promoters.

The aqueous coating composition has a VOC of less than 100 grams/liter. In one embodiment the VOC is less than 50 grams/liter. The density of the aqueous composition is 8.5 lbs/gal or higher. In one embodiment, the density is in the range of about 8.5 to about 10 lbs/gal, and in one embodiment, in the range of about 8.75 to about 9.5 lbs/gal.

In one embodiment, film formed from the dried coating composition has an elongation, as measured according to ASTM D2370-98 (2002), of greater than 350%. In one embodiment, the elongation is at least 400%, and in yet another embodiment, the elongation is at least 450%, or at least 475%.

The coating composition may be applied in an amount of about 4 to about 5 gal/100 ft² and dried to form a protective coating without cracking. The thickness of the coating composition is generally in the range of about 50 to about 100 mils (about 1.27 to about 2.54 mm), or about 60 to about 90 mils (about 1.52 to about 2.29 mm), or about 65 to about 80 mils (about 1.65 to about 2.03 mm). The thickness of the dried protective coating (without the aggregate embedded therein) is in the range of about 45 to about 60 mils.

The aggregate material is at least partially embedded in the coating composition. Typically, the aggregate is embedded to a depth of at least one-half of its diameter, or to a depth of at least two-thirds of its diameter. The aggregate may comprise rock or mineral material in its natural form or colored by ceramic processes. Particularly useful aggregate material has an initial solar reflectance of at least 70% and a thermal emittance of at least 0.75. Thus aggregate material that is light in color is particularly preferred, as it absorbs less solar radiation.

In addition to providing solar reflectance and thermal emittance, the aggregate is used to provide weather protection to the underlying roof surface, improve the fire rating, reduce photo degradation, improve impact resistance (e.g., hail damage and foot traffic), and improve slip resistance of the roofing surface.

Suitable aggregate material can be selected from a wide class of relatively porous or non-porous and weather-resistant rock or mineral materials. Suitable materials include limestone, marble, granite, gravel, volcanic rock, slag, and other natural and synthetic materials that have been coated with ceramic. Preferably, the aggregate is derived from relatively non-porous material. The size of the aggregate may vary. Typically, the aggregates have an average particle diameter in the range of about ¼ inch to about 2 inches, or in the range of about ¼ inch to about 1 inch, or in the range of about ⅜ inch to about ⅝ inch.

The average hardness of the aggregate is generally in the range of about 4.5 to about 10 Moh's hardness. In one embodiment, the average hardness of the aggregates is about 6.0 to about 10 Moh's hardness. In another embodiment, the average hardness of the aggregates is about 7 to about 9.5 Moh's hardness.

In one embodiment, the aggregate is ceramic coated natural rock having an average diameter of ⅜ inch, a solar reflectance of 72% (as measured by ASTM C-1549-02) and a thermal emittance of 0.78 (as measured by ASTM C1371-98).

The amount of aggregate applied depends in large part on the type of aggregate used. Where No. 11 aggregate is used, for example, 60 lbs of aggregate per 100 square feet of roofing substrate is typical. Where full size gravel is used, 400-500 lbs. of aggregate per 100 square feet of roofing substrate is more typical. In general, the amount of aggregate used will typically be sufficient to provide at least about 50 lb., more typically at least about 100 lbs., at least about 150 lbs., at least about 175 lbs., or at least about 200 lbs. aggregate, per 100 square feet of roofing application.

### EXAMPLES

### Example 1

### Coating Composition

An aqueous coating composition was prepared by mixing the ingredients listed in Table 1 below.

TABLE 1

| Ingredient | | Wt % |
|---|---|---|
| Water | vehicle | 24.23% |
| Natrosol 250 MR | Hydroxyethyl cellulose, | 0.43% |
| | rheology modifier | |
| KTPP | Potassium tripolyphosphate, | 0.13% |
| | sequestrant | |
| Tamol 731A | Polymeric dispersant | 0.61% |
| Foamaster NXZ | Defoamer | 0.34% |
| Titanium Dioxide R 902 | Pigment | 10.08% |
| SB336 Alumina Trihydrate | Flame retardant | 17.92% |
| Texanol | Ester alcohol, coalescent | 0.61% |
| Ethylene glycol | Antifreeze | 1.35% |
| Texicryl 13-034 | Styrene acrylic copolymer | 40.89% |
| Mineral spirits | solvent | 2.00% |
| Dualite E065-135D01 | filler | 0.57% |
| Polyphase 663 | fungicide | 0.82% |
| Total | | 100% |

The coating composition of Example 1 has the following properties:

| | |
|---|---|
| Viscosity [ASTMD2196-86 (1991)]: | 15,000-25,000 cps |
| Density [ASTM D-6511-00]: | 9.0-9.5 lbs/gal |
| Nonvolatile content [ASTM D-6511-00]: | 50% ± 2% |
| VOC [ASTM D93-97]: | <50 g/l |

### Example 2

### Cool Roof Covering

A cool roof covering is made by applying the aqueous coating composition of Example 1 to a modified bitumen substrate in an amount of 4 lbs/100 ft². Before the coating composition is dry, a white, ceramic coated aggregate having an average diameter of ⅜ inch (Glacer White from A-1 Grit Company) is applied to the coating composition in an amount of 200 lbs/100 ft². The aggregate is embedded by gravity up to about ⅔ of its diameter. The roof covering is weather resistant within a few hours of application. After about 30 days, the protective coating is fully dried. The cool roof covering has a solar reflectance of 72% (as measured by ASTM C-1549-02) and a thermal emittance of 0.78 (as measured by ASTM C1371-98).

### Test Methods

The properties of the aqueous coating composition of Example 1 were evaluated according to the following test methods:

### A. Tensile/Elongation.

A 50 mil thick film of the protective coating was prepared and tested according to ASTM D 2370-98 (2002). Examples 1A and 1B have the same formulation, but were prepared using different batch sizes. Also evaluated were comparative films (50 mils thick) prepared from commercially available roofing compositions: Organic solvent based acrylic (C-1); Water-based acrylic (C-2), and Water-based acrylic (C-3).

Example 1A

| | Load at | Stress at | % Strain at | Maximum | |
|---|---|---|---|---|---|
| | Max. | Max. | Max. | Percent | Maximum |
| | Load | Load | Load | Strain | Displacement |
| | (lbf) | (psi) | (%) | (%) | (in) |
| 1 | 0.659 | 75.349 | 106.700 | 503.806 | 5.038 |
| 2 | 0.706 | 80.629 | 83.600 | 507.465 | 5.075 |
| 3 | 0.689 | 78.789 | 85.900 | 432.974 | 4.330 |
| Mean | 0.685 | 78.255 | 92.067 | 481.415 | 4.814 |
| S.D. | 0.023 | 2.680 | 12.725 | 41.991 | 0.420 |
| C.V. | 3.425 | 3.425 | 13.821 | 8.722 | 8.722 |
| Minimum | 0.659 | 75.349 | 83.600 | 432.974 | 4.330 |
| Maximum | 0.706 | 80.629 | 106.700 | 507.465 | 5.075 |

Example 1B

| | Load at | Stress at | % Strain at | Maximum | |
|---|---|---|---|---|---|
| | Max. | Max. | Max. | Percent | Maximum |
| | Load | Load | Load | Strain | Displacement |
| | (lbf) | (psi) | (%) | (%) | (in) |
| 1 | 0.570 | 59.968 | 77.000 | 496.474 | 4.965 |
| 2 | 0.588 | 61.884 | 75.200 | 445.125 | 4.451 |
| 3 | 0.569 | 59.905 | 66.400 | 484.977 | 4.850 |
| Mean | 0.576 | 60.586 | 72.867 | 475.525 | 4.755 |
| S.D. | 0.011 | 1.125 | 5.672 | 26.948 | 0.269 |
| C.V. | 1.856 | 1.856 | 7.784 | 5.667 | 5.667 |
| Minimum | 0.569 | 59.905 | 66.400 | 445.125 | 4.451 |
| Maximum | 0.588 | 61.884 | 77.000 | 496.474 | 4.965 |

Comparative Example C-1

| | Load at | Stress at | % Strain at | Maximum | |
|---|---|---|---|---|---|
| | Max. | Max. | Max. | Percent | Maximum |
| | Load | Load | Load | Strain | Displacement |
| | (lbf) | (psi) | (%) | (%) | (in) |
| 1 | 0.262 | 21.792 | 6.200 | 36.804 | 0.368 |
| 2 | 0.252 | 20.983 | 5.400 | 56.136 | 0.561 |
| 3 | 0.273 | 22.733 | 6.200 | 60.796 | 0.608 |
| Mean | 0.262 | 21.836 | 5.933 | 51.245 | 0.512 |
| S.D. | 0.011 | 0.876 | 0.462 | 12.722 | 0.127 |
| C.V. | 4.011 | 4.011 | 7.784 | 24.825 | 24.825 |
| Minimum | 0.252 | 20.983 | 5.400 | 36.804 | 0.368 |
| Maximum | 0.273 | 22.733 | 6.200 | 60.796 | 0.608 |

Comparative Example C-2

| | Load at | Stress at | % Strain at | Maximum | |
|---|---|---|---|---|---|
| | Max. | Max. | Max. | Percent | Maximum |
| | Load | Load | Load | Strain | Displacement |
| | (lbf) | (psi) | (%) | (%) | (in) |
| 1 | 2.154 | 200.372 | 146.400 | 165.305 | 1.653 |
| 2 | 2.118 | 197.023 | 163.300 | 179.464 | 1.795 |
| 3 | 2.048 | 190.512 | 128.300 | 145.134 | 1.451 |
| Mean | 2.107 | 195.969 | 146.000 | 163.301 | 1.633 |
| S.D. | 0.054 | 5.014 | 17.503 | 17.253 | 0.173 |
| C.V. | 2.559 | 2.559 | 11.989 | 10.565 | 10.565 |
| Minimum | 2.048 | 190.512 | 128.300 | 145.134 | 1.451 |
| Maximum | 2.154 | 200.372 | 163.300 | 179.464 | 1.795 |

Comparative Example C-3

| | Load at | Stress at | % Strain at | Maximum | |
|---|---|---|---|---|---|
| | Max. | Max. | Max. | Percent | Maximum |
| | Load | Load | Load | Strain | Displacement |
| | (lbf) | (psi) | (%) | (%) | (in) |
| 1 | 2.705 | 318.235 | 18.500 | 30.466 | 0.305 |
| 2 | 2.729 | 321.059 | 17.100 | 30.797 | 0.308 |
| 3 | 2.768 | 325.647 | 20.400 | 34.797 | 0.348 |
| Mean | 2.734 | 321.647 | 18.667 | 32.020 | 0.320 |
| S.D. | 0.032 | 3.741 | 1.656 | 2.411 | 0.024 |
| C.V. | 1.163 | 1.163 | 8.873 | 7.529 | 7.529 |
| Minimum | 2.705 | 318.235 | 17.100 | 30.466 | 0.305 |
| Maximum | 2.768 | 325.647 | 20.400 | 34.797 | 0.348 |

Table 2 summarizes the results of the elongation testing.

TABLE 2

| | Mean |
|---|---|
| Sample | Elongation (%) |
| Example 1A | 481.415 |
| Example 1B | 475.25 |
| Comparative C-1 | 51.245 |
| Comparative C-2 | 163.301 |
| Comparative C-3 | 32.020 |

### B. Ponding Water Test.

The protective coating of an embodiment of the present invention was evaluated for ponding water resistance according to the following test protocol. Also evaluated were the commercially available comparative water based acrylic roofing coatings C-2 and C-3.

Test Procedure: A 3″ inside diameter 40 PVC-DWV cell core pipe is cut into 1½″ long pieces with a pipe cutter. The ends are sanded to make a good contact on test material. Dyed water is prepared using 8 fluid ounces of red Rit Liquid Dye to two gallon of hot water and then filtered.

Apply test material to release paper, applied thickness to be determined by end application or test requirements. Air dry one week. Scotch tape filter paper to a 6 inch by 6-inch piece of glass. Cut a 5⅛″ diameter circle from the test material. The minimum size circle should not be less than 4 inches in diameter. Carefully remove test material from release paper. Scotch tape perimeter of test material to filter paper/glass.

Mark a one-inch depth inside the cylinder with a marker. Apply acrylic latex caulk to the base of the cylinder which indicates a one-inch depth. With slight pressure, apply the cylinder to the test material, air dry one week. After the assembly has dried for one week, fill the cylinder to the one-inch depth line with dyed water. Refill the cylinders with water every 4 or 5 days as needed due to water evaporation.

Test Results: A film having thickness of 40 mils was prepared from the coating composition of Example 1, and from the coating compositions of commercially available coatings C-2 and C-3. The ponding water test was conducted over a three-week period, during which the cylinders over the films were refilled with dyed water. A test result of “pass” is indicated where the filter paper positioned beneath the film showed little or no faint red spots. A test result of “fail” is indicated where the filter paper positioned beneath the film shows significant red stains covering at least 50% of the surface of the filter paper.

TABLE 3

| Sample | Test Result |
|---|---|
| Example 1A | Pass |
| Example 1B | Pass |
| Example C-2 | Fail |
| Example C-3 | Fail |

The protective coating of the cool roof covering described herein exhibits superior elongation. The protective coating has the ability to expand and contract with the changes in temperature and is able to move with the underlying roofing structure. In addition, the protective coating exhibits superior impact resistance and compatibility with the underlying substrate. The protective coating exhibits superior water resistance as indicated by the ponding water test.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A cool roof covering comprising:
a substrate having an upper surface;
a protective coating covering at least a portion of the upper surface of the substrate, wherein the coating is the dried film of an aqueous composition comprising (a) a water resistant styrene-acrylic emulsion polymer, (b) at least one reflective pigment, (c) a flame retardant, and (d) a light weight filler having a density of no greater than 0.7 lb/gal (0.084 g/cc); and
a layer of aggregate at least partially embedded in the protective coating;
wherein the cool roof covering has a solar reflectance of at least 70% and a thermal emittance of at least 0.75.

2. The roof covering of claim 1 wherein the aqueous composition has a VOC of less than 50 grams/liter.

3. The roof covering of claim 1 wherein the water resistant styrene-acrylic emulsion polymer has a Tg of about 7° C. and a minimum film forming temperature (MFFT) of <2° C.

4. The roof covering of claim 1 wherein the reflective pigment is selected from rutile titanium dioxide, anatase titanium dioxide, zinc oxide, zirconium oxide, barium sulfate, titanium calcium, antimony oxide, zinc sulfide and mixtures of two or more thereof.

5. The roof covering of claim 1 wherein the light weight filler comprises a composite microsphere having an acrylonitrile copolymer shell and an exterior coating of calcium carbonate affixed to the shell.

6. The roof covering of claim 1 wherein the aqueous composition has a density in the range of about 8.5 to about 10 lbs/gal.

7. The roof covering of claim 1 wherein the flame retardant is selected from alumina trihydrate, magnesium hydroxide, zinc borate and mixtures of two or more thereof.

8. The roof covering of claim 1 wherein the aggregate has a solar reflectance of about 72% and a thermal emittance of about 78%.

9. The roof covering of claim 1 wherein the aggregate is selected from granite, marble, limestone, and ceramic coated rock and mineral material.

10. The roof covering of claim 1 wherein the aggregate comprises ceramic coated natural rock having a solar reflectance of 72% and a thermal emittance of 0.78.

11. The roof covering of claim 1 wherein the substrate comprises a built up roof (BUR).

12. The roof covering of claim 1 wherein the substrate comprises a modified bitumen (MB) substrate.

13. The roof covering of claim 1 wherein the dried coating composition has an elongation (according to ASTM D2370) of at least 400%.

14. A cool roof coating comprising the dried film of an aqueous composition comprising (a) a water resistant styrene-acrylic emulsion polymer, (b) at least one reflective pigment, (c) a flame retardant, and (d) a light weight filler having a density of no greater than 0.7 lb/gal (0.084 g/cc), wherein the coating has an elongation (according to ASTM D2370) of at least 400%.

15. The cool roof coating of claim 14 wherein the aqueous composition has a VOC of less than 50 grams/liter.

16. The cool roof coating of claim 14 wherein the water resistant styrene-acrylic emulsion polymer has a Tg of about 7° C. and a minimum film forming temperature (MFFT) of <2° C.

17. The cool roof coating of claim 14 wherein the aqueous composition has a density in the range of about 8.5 to about 10 lbs/gal.

18. The cool roof coating of claim 14 wherein the reflective pigment is selected from rutile titanium dioxide, anatase titanium dioxide, zinc oxide, zirconium oxide, barium sulfate, titanium calcium, antimony oxide, zinc sulfide and mixtures of two or more thereof.

19. The cool roof coating of claim 14 wherein the flame retardant is selected from alumina trihydrate, magnesium hydroxide, zinc borate and mixtures of two or more thereof.

20. The cool roof coating of claim 14 wherein the light weight filler comprises a composite microsphere having an acrylonitrile copolymer shell and an exterior coating of calcium carbonate affixed to the shell.
